(19) United States
(12) Patent Application Publication
(10) Pub. No.: US 2003/0023745 A1
(43) Pub. Date: Jan. 30, 2003

(54) Method and system for adaptively downloading data from a network device

(75) Inventor: Michael J. Noe, Scottsdale, AZ (US)

Correspondence Address: MORGAN LEWIS & BOCKIUS LLP, 1111 PENNSYLVANIA AVENUE NW, WASHINGTON, DC, 20004, US

(73) Assignee: NeoPlanet, Inc.

(21) Appl. No.: 09/912,383

(22) Filed: Jul. 26, 2001

(51) Int. Cl. G06F 15/16

(52) U.S. Cl. 709/235; 709/224

(57) ABSTRACT

A client-based method and system for managing the transfer of a file having data from a networked device to a client system having a network connection. The method involves monitoring the utilization of the network connection and determining whether to receive data based on the utilization of the network connection. It is determined to receive data, the method includes the steps of determining whether to adjust the amount of data received in the current iteration, adjusting the amount of data to receive according to the network connection type, and receiving the amount of data. If it is determined not to receive data, the method pauses a predetermined amount of time before proceeding.

### BACKGROUND OF THE INVENTION

1. Field of the Invention

The present invention relates to a method and system for downloading data, and more particularly, to a method and system for efficiently downloading data during periods of low network activity.

2. Discussion of the Prior Art

Virtually all segments of society are increasingly using one or more networks for performing daily and work-related tasks. For example, many businesses have internal intranets that enable employees to efficiently exchange data, share documents, and receive company and work-related information. Likewise, using a public network such as the Internet, a user may, for example, retrieve information, pay bills, download music, make purchases, or simply browse the Web as a form of entertainment.

Depending on the type of task, users often attempt to conduct simultaneous tasks or multiple tasks within one connection period. These tasks may be user or server driven. For example, a user may attempt to retrieve and read e-mail messages while downloading a file from an FTP site or from a peer network device. In another example, a user may simply be browsing the Web when a server-based routine initiates and manages the transfer of data to the user's machine. In this scenario, the server may preposition advertisements on the client system for later viewing.

Although the user's network activity is restricted by the capacity of the network connection, various techniques have been developed that enable a user to conduct multiple networked-based tasks. For instance, current client-based download managers allow the user to schedule one or more downloads while the user performs other network dependent tasks, such as browsing. Furthermore, some server-based applications manage the dissemination or transfer of data to various users during an active network connection. However, current techniques for managing the transfer of data between networked devices.

First, current so-called “background downloading” techniques interfere with the user's foreground activity, such as browsing. Although existing download managers enable multiple downloads to proceed while the user performs other tasks, the data transfer requirements of one or more downloads usually dominate the available bandwidth. Therefore, the user experiences substantial delays in accomplishing foreground tasks. In other words, the bandwidth requirements of the background download degrades the user's ability to perform such foreground tasks as loading and viewing Web pages.

Second, current downloading techniques inefficiently utilize the available network resources of the user's computer system. Instead of maximizing available network resources, some download managers are statically configured to only use a set percentage of a user's bandwidth, for example 10% or 90% of capacity. Thus, the remaining bandwidth dedicated to the user's foreground task is underutilized during periods of low user activity. Therefore, while the user is reading an e-mail retrieved from a server or reading a Web page that has been fully rendered, the available bandwidth dedicated to the user's current task remains unused.

Third, some download managers or applications that are server-based or server/client based have limited versatility because they require that specific software be installed on the server. Because the user can only download data from proprietary servers, these download techniques are incompatible with standard servers.

Finally, some current download techniques are unreliable and have increased bandwidth requirements because they utilize the User Datagram Protocol (UDP). Downloading techniques that broadcast or multicast data to multiple clients typically use UDP. However, because UDP does not establish an end-to-end connection, some data packets sent by the server are never received by the client. Due to the unreliability of UDP, additional bandwidth is consumed in re-sending lost packets. Moreover, the user's network device expends additional resources in processing UDP packets that are not verified and accepted.

In light of the foregoing, there is a need for a method and system for managing the transfer of data between networked devices that does not interfere with the user's foregoing network activity. Moreover, there is a need for a method and system compatible with standard servers and network protocols for downloading data that efficiently utilizes available bandwidth.

### SUMMARY OF THE INVENTION

Accordingly, the present invention is directed to a method and system for adaptively downloading data from a network device that substantially obviates one or more of the problems due to limitations and disadvantages of the related art.

One object of the present invention is to provide a method and system for transferring data to a user's computer from a network device that does not interfere with the user's other network dependent activities.

Another object of the present invention is to provide a method and system for downloading data when the user's network connection is under-utilized.

Another object of the present invention is to provide a method and system for detecting when the user's network connection is under-utilized.

Another object of the present invention is to provide a method and system for managing the downloading of data from a network device depending on the client system's network connection type and available bandwidth.

A further object of the present invention is to provide a method and system for efficiently downloading data depending on detected network activity.

A further object of the present invention is to provide a method and system for adjusting the amount of data that is downloaded during subsequent detections of low network utilization.

A further object of the present invention is to provide a method and system for progressively increasing the amount of data this is downloaded during a period of low network activity thereby increasing the efficiency of the download during long periods of inactivity.

Yet another object of the present invention is to provide a client-based method and system for transferring data to the client system during periods of low network activity.

Yet another object of the present invention is to provide a reliable method and system for downloading data that is compatible with popular Internet protocols.

Yet another object of the present invention is to provide a reliable method and system for downloading data that is compatible with standard, widely installed servers.

Additional objects and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows an exemplary environment for implementing one embodiment of the present invention;

FIG. 2 is a block diagram of an exemplary computer system for implementing one embodiment of the present invention;

FIG. 3 graphically depicts a network connection utilization curve for an exemplary network session;

FIG. 4 is a flow diagram showing a general overview of a method for downloading data according to one embodiment of the present invention;

FIGS. 5A-5B are flow diagrams showing a detailed method for downloading data according to one embodiment of the present invention;

FIG. 6 shows an exemplary user interface for configuring parameters according to one embodiment of the present invention;

FIG. 7 is a table showing exemplary values for downloading parameters according to one embodiment of the present invention;

FIG. 8 graphically depicts network activity for an exemplary network session and corresponding network monitoring according to one embodiment of the present invention;

FIG. 9 shows the downloading of data using buffers of the server and client systems according to one embodiment of the present invention;

FIG. 10 is a flow diagram of an alternative embodiment for resuming the download after yielding a certain amount of time;

FIG. 11 is a table showing exemplary values for downloading parameters according to one embodiment of the present invention; and

FIG. 12 is a flow diagram of an alternative embodiment for adapting the Sample Rate during a period of high network activity according to one embodiment of the present invention.

### DETAILED DESCRIPTION OF THE PREFERRED EMBODIMENTS

Certain terminology is used herein for convenience only and is not to be taken as a limitation on the present invention.

Reference will now be made in detail to the preferred embodiments of the present invention, examples of which are illustrated in the accompanying drawings. Wherever possible, the same reference numbers will be used throughout the drawings to refer to the same or like elements.

Environment

The method and system for adaptively downloading data may be implemented in a network environment that is configured to utilize a non-repudiation protocol. A network comprises a server, computer systems and peripherals, such as printers and other devices that may be shared by components of the network. The computer systems may serve as clients for server and/or as clients and/or servers for each other and/or for other components connected to the network. Components on the network are preferably connected together by cable media, for example copper or fiber-optic cable. It should be apparent to those of ordinary skill in the art that other media, for example, wireless media, such as optical and radio frequency, may also connect network components. It should also be apparent that various network topologies including, but not limited to, Ethernet and token rings, may be used.

Data may be transferred between components on the network in segments (or packets), i.e., blocks of data that are individually transmitted. Routers may create an expanded network by connecting to other computer networks, such as the Internet, LANs or Wide Area Networks (WAN). Routers are hardware devices that may include a conventional processor, memory, and separate I/O interface for each network to which it connects. Hence, components on the expanded network may share information and services with each other. In order for communications to occur between components of physically connected networks, all components on the expanded network and the routers that connect them must adhere to a standard protocol. Computer networks connected to the Internet and to other networks typically use TCP/IP Layering Model Protocol. It should be noted that other internetworking protocols may be used.

The TCP/IP Layering Model comprises an application layer, a transport layer, an Internet layer, a network interface layer, and a physical layer. Application layer protocols specify how each software application connected to the network uses the network. Transport layer protocols specify how to ensure reliable transfer among complex protocols. Internet layer protocols specify the format of packets sent across the network as well as mechanisms used to forward packets from a computer through one or more routers to a final destination.

Network interface layer protocols specify how to organize data into frames and how a computer transmits frames over the network. Physical layer protocols correspond to the basic network hardware. By using TCP/IP Layering model protocols, any component connected to the network can communicate with any other component connected directly or indirectly to one of the attached networks.

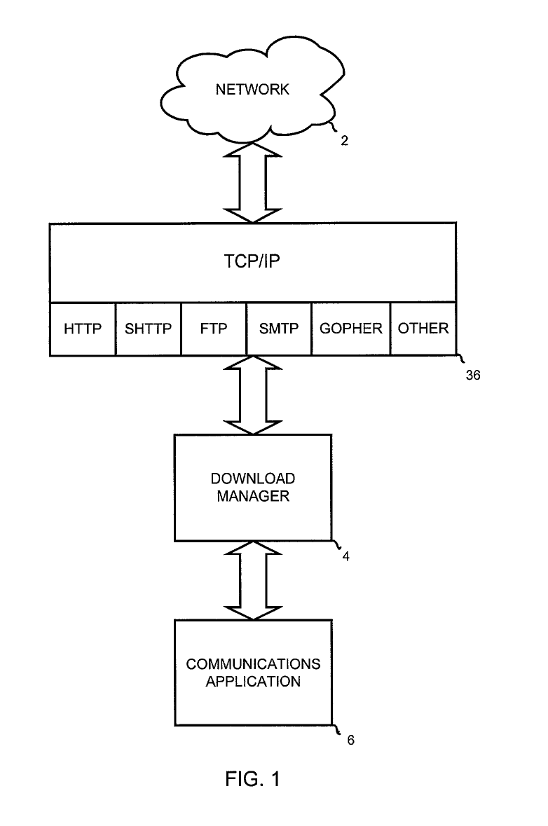

As shown in FIG. 1, the system of the present invention may be implemented with any of the protocols supported by TCP/IP 36, including, but not limited to, the Hypertext Transfer Protocol (HTTP), the Secure Hypertext Transport Protocol (SHTTP), and the File Transport Protocol (FTP). FIG. 1 also shows one embodiment of the present invention implemented as a stand-alone application 4 managing the download task of another application 6 residing on a client system attached to a network 2. One skilled in the art will appreciate that the present invention may also be embedded in the shell of a client application, such as a Web browser, for example.

System Hardware

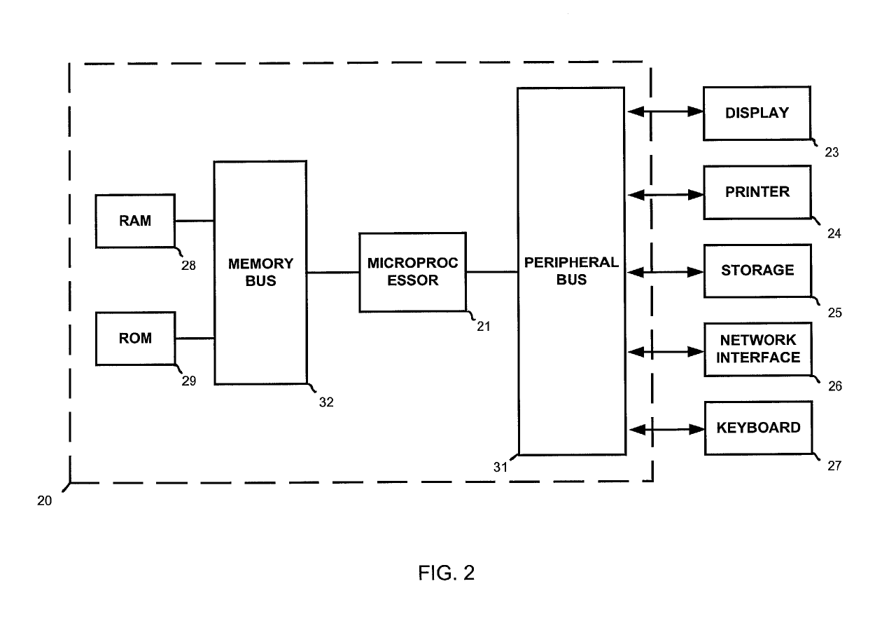

FIG. 2 is a block diagram of an exemplary computer system 20 for carrying out the downloading technique according to one embodiment of the present invention. Computer system 20, or an analogous one, may be employed to implement either a client or a server of a computer network. The computer system 20 includes a microprocessor 21, memory bus 22, display screen (or monitor) 23, printer 24, hard disk drive (or storage) 25, network interface 26, keyboard 27, random access memory (RAM) 28, read only memory (ROM) 29, peripheral bus 31, and a memory bus 32.

The microprocessor 21 is a general purpose digital processor which controls the operation of the computer system 20. The memory bus 32 is used by the microprocessor 21 to access the RAM 28 and the ROM 29. The peripheral bus 31 is used to access the input, output, and storage devices used by the computer system 20. The microprocessor 21 together with an operating system operate to execute computer code and produce and use data.

The computer code and data may reside on the RAM 28, ROM 29, the hard disk drive 25, or even on another computer on the network. The computer code and data could also reside on a removable program medium and loaded or installed onto the computer system 20 when needed. Removable program mediums include, for example, CD-ROM, PC-CARD, floppy disk and magnetic tape. The network interface circuit 26 is used to send and receive data over a network connected to other computer systems. An interface card or similar device and appropriate software implemented by the microprocessor 21 can be used to connect the computer system 20 to an existing network and transfer data according to standard network protocols.

The present invention, however, is not limited to any particular computer system, operating system, or network environment. Instead, those skilled in the art will appreciate that the method and system of the present invention may be advantageously implemented using a variety of computer systems and operating systems.

System Software

The software of the present invention implemented on computer system 20 can be written in any suitable high level computer language. In the present embodiment, the software is written using the C++programming language.

General Overview

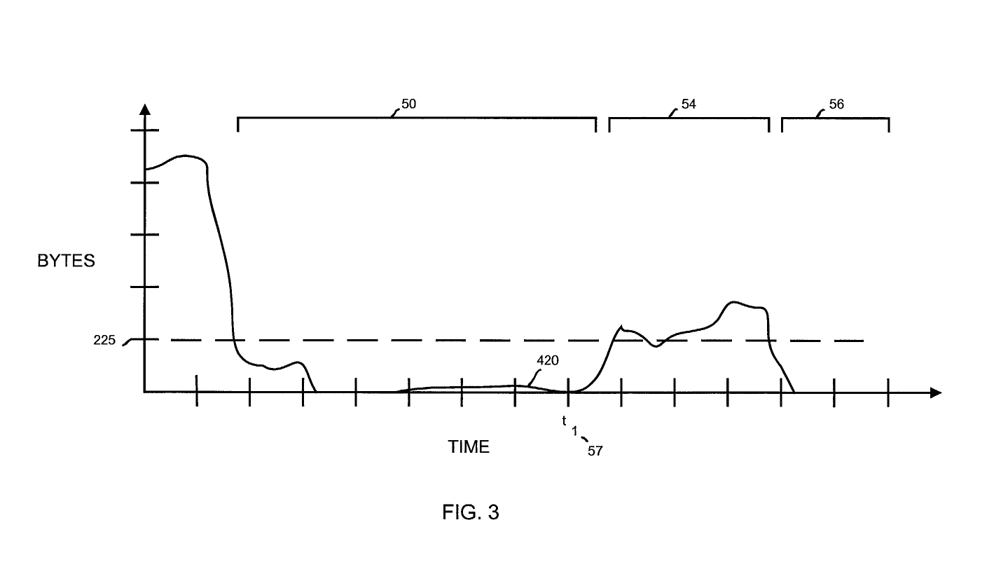

As shown graphically in FIG. 3, the Internet activity associated with typical network communication applications, such as an Internet browser, occurs in spurts or waves of activity. For instance, region 50 represents a period of time in which the client's network resources are under-utilized. Depending on the network connection type, a certain amount of low level network activity, also known as noise 420, maintains the network connection. Typically, the network activity that occurs below a defined Threshold Noise Level 225 (i.e., noise threshold), is considered noise 420 associated with any network connection type. However, when a user initiates a network task at time t1 57, a period of increased network activity may be observed.

The wave of network activity identified by region 54 may, for example, represent the rendering of a Web page, the downloading of a music file, or retrieval of stock quotes from an FTP or HTTP site. Typically, after an interval of network activity identified by region 54, the network connection will again be under-utilized for a variable amount of time indicated by region 56 in FIG. 3. To avoid disrupting or degrading the user's foreground network activity, such as browsing, the method and system of the present invention adaptively downloads data during the periods of low network activity.

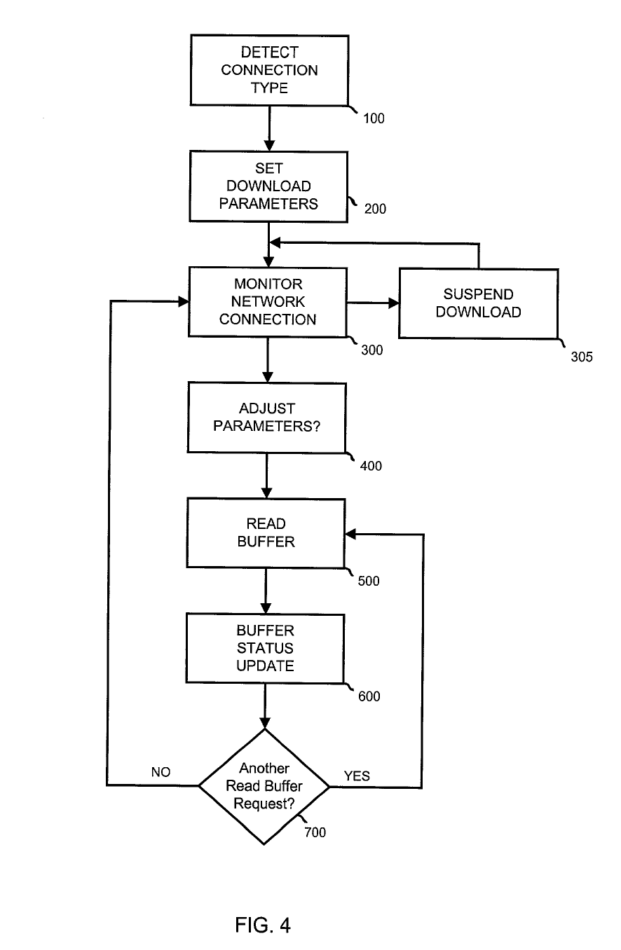

FIG. 4 shows a general overview of a method for adaptively downloading data according to one embodiment of the present invention. Each step will be discussed in greater detail below. After a network connection has been properly established and a download object has been identified for downloading to the client, the system at step 100 initially detects the current network connection speed. As one skilled in the art will appreciate, besides downloading an object from a server to a client, for example, an object may also be transferred from any networked device to the user's system.

Based on the detected speed, which indirectly indicates the network connection type the client is utilizing (e.g., dialup modem, LAN, or cable modem), the system at step 200 automatically configures default parameters for controlling the download process. In an alternative embodiment of the present invention, information regarding the network connection type and associated network capacity may be provided by the operating system. According to the type of network connection detected in step 100, the system at step 200 automatically sets the Threshold Noise Level 225, the network activity Sample Rate, the receiving Buffer Size, and the adaptive Read Buffer parameter that determines the amount of data the system retrieves before checking for network activity.

Both the receiving Buffer Size parameter and the adaptive Read Buffer parameter determine the amount of data downloaded and the aggressiveness in which the downloading is performed during a period of low network activity. To download the identified object without interfering with the user's foreground network dependent task or tasks, the present embodiment monitors current network activity of the client at step 300. If the current network activity detected is below a predefined noise threshold 225, the system proceeds with the downloading task. Otherwise, the system temporarily suspends the download at step 300 and continues to monitor the network connection for inactivity at step 300.

After detecting an idle period or a period of low network activity at step 300, the system determines at step 400 whether to adjust the adaptive Read Buffer parameter. Since the current download period followed a period of network activity, the system assumes the least aggressive download posture and uses default settings for determining how often to check for network activity. Using an API function call, the system at step 500 reads or empties the receiving buffer that receives data from the local TCP buffer. After confirming the status of the buffer read with the server or host at step 600, the present embodiment determines at step 700 whether to read the receiving buffer again. Accordingly, steps 500 through 700 are repeated until the desired number of buffer reads are performed or an end of file (EOF). If there is additional data to download and the specified number of Read Buffers has been performed, the present embodiment measures the network connection at step 300 to determine whether the user has resumed any network dependent foreground tasks.

If significant network activity is detected at step 300, the present embodiment suspends the downloading at step 305 during pendency of the foreground task. On the other hand, if the network activity detected at step 300 is again below a noise threshold value 225, the download task continues at step 400. If successive network traffic checks at step 300 reveal low network activity, the present embodiment adjusts the adaptive Read Buffer parameter at step 400. The system of the present embodiment may assume a more aggressive download posture by retrieving more data (i.e., reading more receiving buffers) between checks for network traffic. In particular, the number of buffer reads may be incremented according to a predetermined parameter that reflects the network connection type.

Therefore, after subsequent negative detections of user foreground activity at step 300, the number of buffer reads can be progressively increased at step 400 until a maximum, predefined value is achieved, the download is completed, or other network activity is detected. If other network activity is detected at step 300, the downloading of the object is paused, thereby enabling network resources to be dedicated to the user's foreground tasks. When the user's network activity subsides and the download task is resumed, the Read Buffer parameter corresponding to the number of buffer reads is reset to the default or minimum value at step 400.

Detailed Embodiment

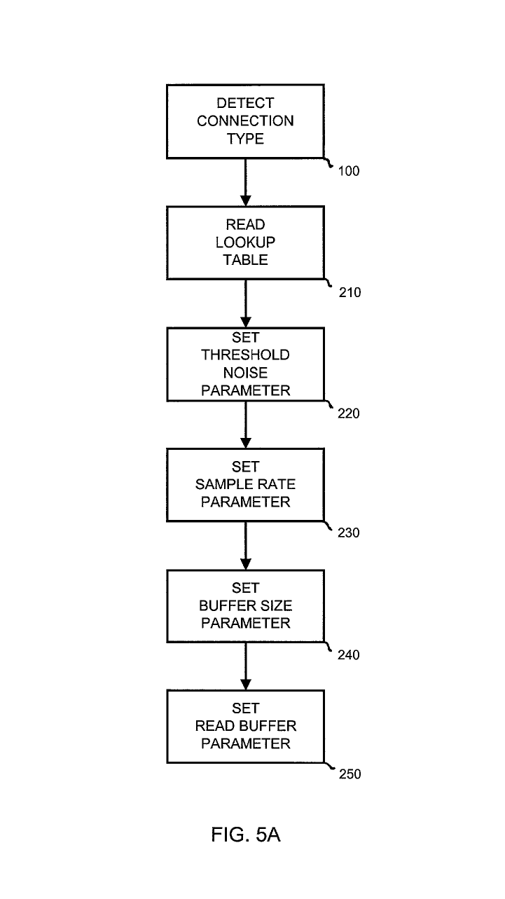

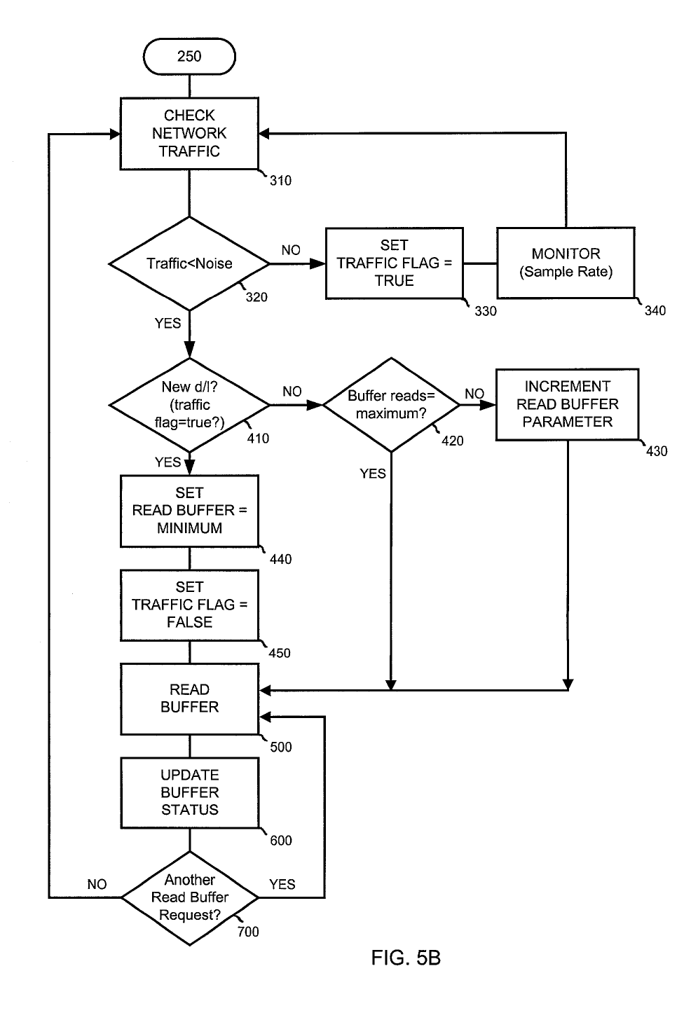

The steps of FIG. 4 are shown in more detail in FIGS. 5A-5B. In one embodiment of the present invention, the system controls the download of the data using an API or some other communications interface known to those skilled in the art. Using an operating system that supports thread functionality, a client or main thread manages the adaptive download method and system while a second worker thread manages the actual file transfer task using standard API functions and calls.

Assuming that an active Internet connection to an IP address or URL has been established and that an object at the destination address has been identified for downloading, the present embodiment at step 100 of FIG. 5A detects the current network speed. Specifically, the system “pings” the particular network resource and records information regarding the speed (i.e., bytes/second) in which data is received from the destination address. If no connection is detected, the system assumes a conservative, default value as the connection speed. Alternatively, some operating systems, which are well known in the art, may provide standard information regarding installed network connection devices and associated connection speed.

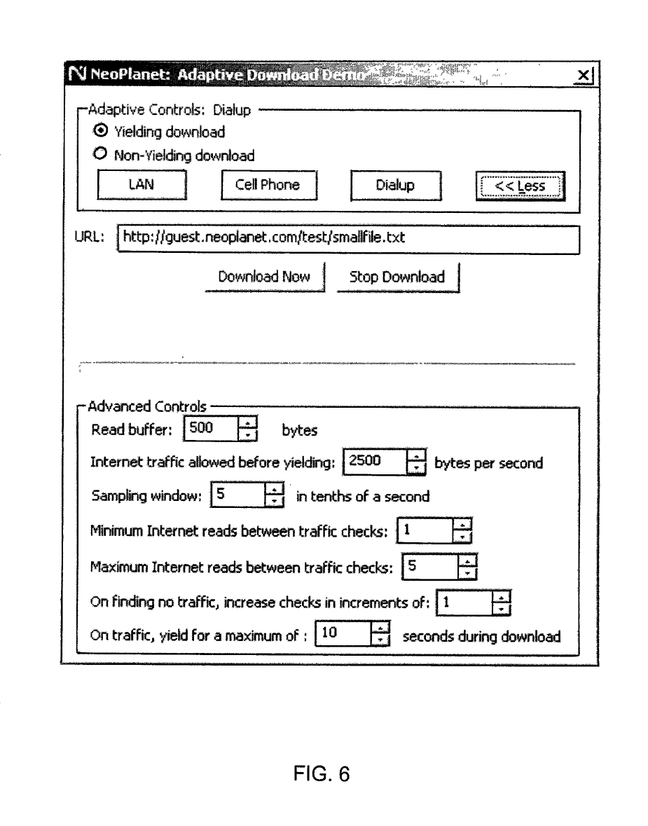

Then in steps 210 through 240 of FIG. 5A, the system of the present embodiment automatically configures the download parameters for the current download session. Based on the connection speed detected in step 100, the system automatically retrieves corresponding default parameters from a lookup table at step 210. For example, if a connection speed that typically corresponds to a dial-up modem is detected in step 100, default download parameters for a dial-up modem connection type are retrieved from a lookup table stored on the client. As one skilled in the art will appreciate, the lookup table of the present embodiment may be dynamically updated to account for future connection types, for example. Moreover, in an alternative embodiment, the default parameters may be user-configurable or defined using other known techniques in the art. For example, FIG. 6 shows an exemplary user interface for adjusting the download parameters according to one embodiment of the present invention.

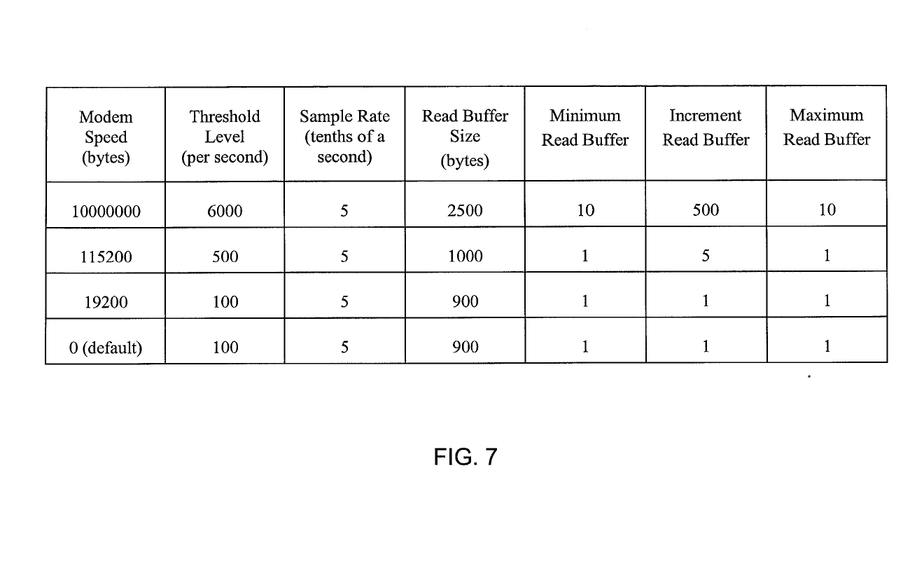

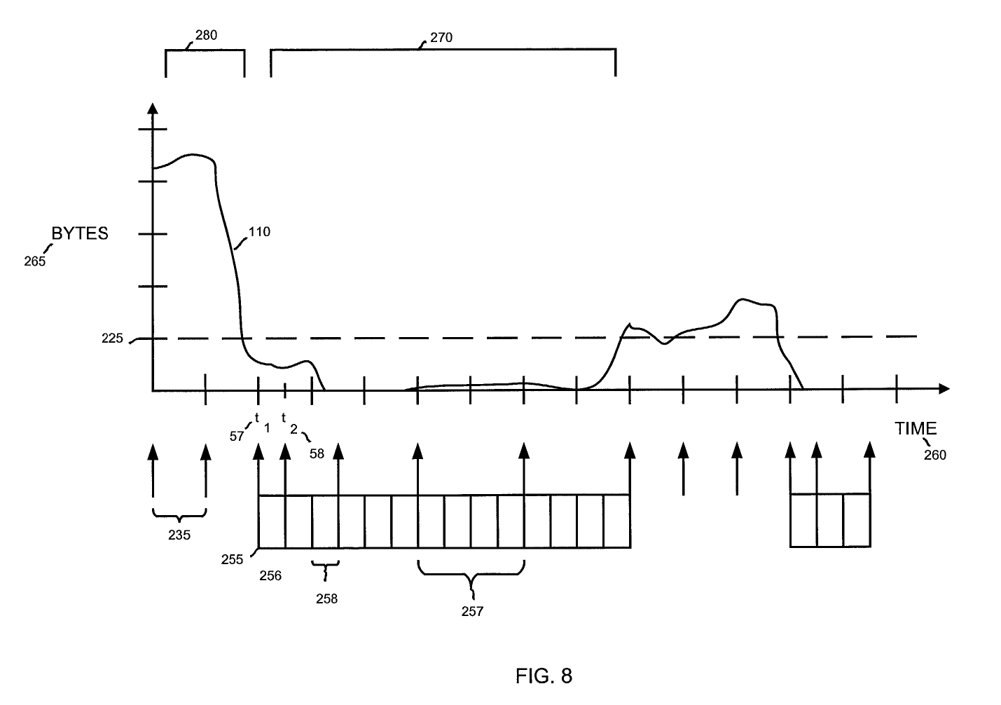

With reference to FIG. 5A, the present embodiment automatically configures four download parameters—a Threshold Noise Level in step 220, a network activity Sample Rate in step 230, a receiving Buffer Size in step 240, and a Read Buffer parameter in step 250. During a downloading operation, the system may adjust the Read Buffer parameter to effectively utilize network capacity during periods of low network activity. In the present embodiment, preferred values for the Threshold Noise Level, Sample Rate, receiving Buffer Size, and Read Buffer parameter corresponding to various connection types are shown in FIG. 7. One of ordinary skill in the art will appreciate that the download parameters are not limited to the values shown in FIG. 7. Each download parameter will now be presented in more detailed with reference to FIG. 8, which depicts the parameters in the context of an exemplary network session.

FIG. 8 shows a plot of the number of bytes 265 downloaded versus time 260 for an exemplary network session. The Threshold Noise Level parameter 225 accounts for the low level network activity associated with any network connection. Typically, network connections, whether a modem, LAN, or other connection type, send and receive small amounts of data to maintain or verify the connection status. For example, region 270 of FIG. 8 may represent a period of time when the user's network activity could be considered idle, even though some network activity is apparent. During an idle period 270, the user may simply be reading a previously downloaded Web page and may not have any outstanding network requests. In contrast, a period of high network activity indicated by region 280 may represent the downloading or rendering of a requested Web page by the user, another download in progress, or any other network activity of a communications application, whether client or server initiated. Since a user's foreground network activity, such as browsing the Internet, would not likely be impaired during an idle period 270 that may include some minimal network activity, the present embodiment resumes the background downloading task when the detected network activity is below a predetermined Threshold Noise Level 225, graphically depicted as a dashed line in FIG. 8.

Because connections with higher bandwidth capacity usually have higher noise levels, the Threshold Noise Level 225 may be configured according to the network connection type that was detected at step 100. For instance, as shown in FIG. 7 a dial-up modem with a connection speed of 19200 bytes/second may have a Threshold Noise Level parameter 225 of 900 bytes/second. Alternatively, the Threshold Noise Level 225 may be defined according to the user's preference.

Increasing or decreasing the values of the Threshold Noise Level 225 affects the sensitivity of the present embodiment to the user's foreground activity. A low Threshold Noise Level 225 would cause no or minimal interference with the user's activity, whereas a higher Threshold Noise Level 225 may cause some degradation. A higher Threshold Noise Level 225 corresponds to a more aggressive download posture. Therefore, background downloading would start sooner and end later, thereby resulting in a faster download; however, at the expense of the user's online experience.

A second download parameter, the network activity Sample Rate 235, determines how often the system of the present invention examines the network connection for activity while a download task is pending. Therefore, if network activity above the noise threshold 225 has been detected, the system will wait an amount of time specified by the Sample Rate parameter 235 before checking the network connection again. As shown graphically in FIG. 8, during a period of network activity 280 when downloading has been suspended, the present embodiment checks the network connection for activity at a predetermined Sample Rate 235 to determine whether favorable downloading conditions exist.

For slow network connections, such as a dial-up modem, the system is preferably more aggressive in monitoring the connection for yielding conditions. However, an overly robust Sample Rate 235 may degrade the computer system's performance. Exemplary Sample Rate parameters 235 for the present embodiment are shown in the third column of the table shown in FIG. 7.

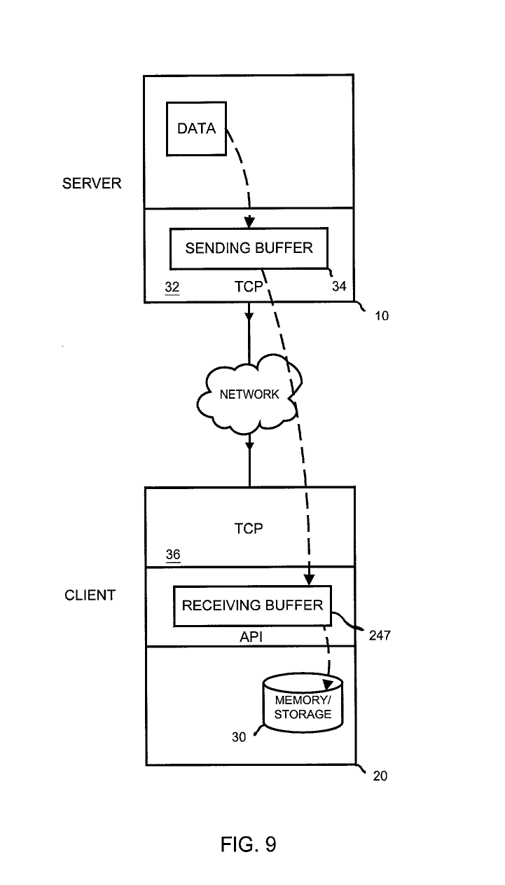

The Buffer Size parameter along with the Read Buffer parameter control the flow of data during an idle period 270 (i.e., download period) when the detected network activity 110 is below the Threshold Noise Level 225. In the present embodiment these values are tuned according to the type of connection network connection and the desired characteristics of the download (i.e., the aggressiveness of the download). Referring to FIG. 9, the Buffer Size parameter controls the size of the receiving buffer 247 of the API.

As previously mentioned, the system of the present invention is preferably implemented using the TCP transport-layer protocol, which provides enhanced reliability compared with the UDP transport service.

When data is transferred from a server 10 to client 20 over TCP, the sending TCP 32 queues data in a sending buffer 34. The data are combined into a segment and passed to the IP for delivery to the client 20. However, the sending TCP 32 can only send as much data that will fit within the buffer of the local TCP 36. Therefore, by adjusting the size of the receiving buffer used to retrieve data from the local TCP buffer, the present embodiment can control the flow of data from the server 10 to the client system 20. Moreover, the size of the receiving buffer 247 also affects the data transfer rate.

In one scenario, the present embodiment may be configured to initially check the network connection after emptying the receiving buffer three times, for example. So for a receiving buffer 247 that is 500 bytes in size, a maximum of 1500 bytes of data could be transferred before the present embodiment checks for network activity. In contrast, a larger receiving buffer 247 set at 1000 bytes could transfer a maximum of 3000 bytes before the next network check. Therefore, a smaller receiving buffer 230 entails more network checks and a slower data transfer rate.

TCP can only send data when space is available in the client's local TCP buffer. Therefore, the frequency at which the data in the receiving buffer 247 is read and recorded in client memory 30 affects the rate at which the server 01 sends data to fill the local TCP buffer. A smaller buffer 247 can be filled and emptied faster than a larger buffer 247, however, a small Buffer Size may also waste network bandwidth. To maximize throughput the receiving buffer 247 should be managed efficiently. In light of the above factors and the type of network connection detected, the present embodiment automatically configures the size of the receiving buffer 247 to a predetermined value selected according to the results of network capacity tests.

Finally, with reference to FIG. 8, the present embodiment automatically configures an initial Read Buffer parameter 255 that indirectly determines how often the present embodiment checks for network activity during a download period 270. Specifically, the adaptive Read Buffer parameters 255 determines how many times the receiving buffer 247 is emptied (i.e., how much data is transferred) before checking for network activity 10. Depending on detected network activity, the Read Buffer parameter 255 may be adjusted according to three parameters—a Minimum Read Buffer parameter 256, a Maximum Read Buffer parameter 257, and an Increment parameter 258. Increasing the number of buffer reads 255 after successive detections of network activity 110 below a Threshold Noise Level 225, enables more data to be transferred. In other words, the amount of data transferred between network checks may be progressively increased during a download period 270.

As shown in FIG. 8, after a period of high network activity 280 the Minimum Read Buffer parameter 256 initially determines the number of times data is retrieved from the receiving buffer 247. If the network activity 110 detected at time t₂ 58 is below the Threshold Noise Level 225, the present embodiment increases the Read Buffer parameter 255 according to the Increment parameter 258. For example, if the Minimum Read Buffer parameter 256 and Increment parameter 258 are set at one and two respectively, the present embodiment would perform 1 buffer read 255 after resuming the download at time t₁ 57. If the network activity at time t₂ 58 is still below the Threshold Noise Level 225, then the number of buffer reads 255 is increased by a factor equal to the Increment parameter 258. In this scenario, the Read Buffer parameter would have a value of two. The amount of data downloaded between network activity checks may be progressively increased until the Read Buffer parameter 255 equals a Maximum Read Buffer parameter 257, network activity 110 above the Threshold Noise Level 225 is detected, or the download is completed.

Instead of incrementing the Read Buffer parameter 255 by a factor defined by the Increment parameter 258, one skilled in the art will recognize that the Read Buffer parameter 255 may be adjusted using other techniques known in the art. For instance, the Read Buffer parameter 255 may be incremented by a value based on a mathematical algorithm, measurements of prior network connection activities, statistics reflecting user behavior, or any other technique known in the art.

After setting the download parameters in steps 210 through 250 of FIG. 5A, the present embodiment measures the utilization of the network connection of the client at step 310 shown in FIG. 5B. Using standard API function calls known in the art, the system accesses the network protocol stack, which contains function calls and programs for retrieving information about the physical communication link. By invoking the TCP/IP function calls of the protocol stack, the present embodiment determines how many network interfaces corresponding to the number of network adapters are on the client system. For each interface, the system of the present invention determines how much data has been received. After an elapsed amount of time, the system performs another function call and retrieves the new data amounts. The new data amounts are subtracted from the previous measurement for each interface to determine how much data has passed over the network connection per unit of time.

At step 320, the system compares the network utilization rate with the Threshold Noise Level 225. If the network utilization rate is above the Threshold Noise Level 225 at step 320, the downloading of data from server 10 is halted at step 330 and a flag indicating network traffic is set to “true”. Suspending the download enables the available network resources to be dedicated to the user's foreground task. Therefore, the user may continue to browse or conduct other network dependent activities without having the background download interfere with the user's activities. While in a period of high network activity 280, the system continues to monitor the network connection for inactivity. Namely, after waiting a predetermined amount of time that corresponds to the network activity Sample Rate 235 at step 340, the system then measures the network activity again at step 310. In steps 310 through 340, the present embodiment continues to monitor the network connection in intervals according to the Sample Rate parameter 235 to determine whether to proceed with the download.

If favorable downloading conditions are detected at step 310, the download may be resumed. However, the system first determines the frequency in which the receiving buffer 247 is read during a download period. If the network traffic flag is “true” (i.e, indicating the beginning of a new download period 270), the Read Buffer parameter 255 is reset or defaults to the Minimum Read Buffer value 256 at step 440 and the network traffic flag is set to “false” at step 450.

At step 500 of FIG. 5B of the present embodiment, a Read Buffer request retrieves a block of data from receiving buffer 247. To track the progress of the Read Buffer request, the present embodiment at step 600 utilizes a callback function to notify the worker thread controlling the download task that the receiving buffer 230 has been read. In the event of an EOF, the receiving buffer may be emptied even though the buffer was not full. The callback confirms the status of the buffer 247 state with the host or sending TCP 32. Depending on the progress of the download, the worker thread determines whether to perform another network activity check at step 700. Therefore, invoking TCP/IP function calls through an API, the system of the present embodiment can suspend and resume the download.

If at step 700 of FIG. 5B the requested number of buffer reads 255 has not been completed, the present embodiment repeats steps 500 through 700. Otherwise, the present embodiment returns to step 310 to check the network connection for activity. If the network activity is again below the Threshold Noise Level 225 at step 320, the downloading period 270 proceeds. To determine whether to increase the aggressiveness of the downloading, the system queries, at step 410, whether a new download period is beginning. Since successive measurements of the network connection were below the Threshold Noise Level 225, as reflected by a “false” traffic flag status, the present embodiment may increase the number of buffer read requests 255 performed in steps 500 through 700.

Unless the Read Buffer parameter 255 is equal to the Maximum Read Buffer parameter 257 at step 420, the Read Buffer parameter 255, which controls the frequency of the network connection checks, is increased according to the Increment parameter 258. In other words, during a download period 270 the number of buffer reads 255 may be incrementally increased according to the Increment parameter 258 until the Maximum Read Buffer 257 is reached.

Exemplary Alternative Embodiments

In some circumstances, the user's foreground task may involve downloading a large file, such as a video, sound, or graphics file, that requires substantial bandwidth. In one embodiment of the present invention, the system yields to all other foreground network activities including other download managers. However, in an alternative embodiment of the present invention, an additional download parameter may be defined to override the yielding of a download task.

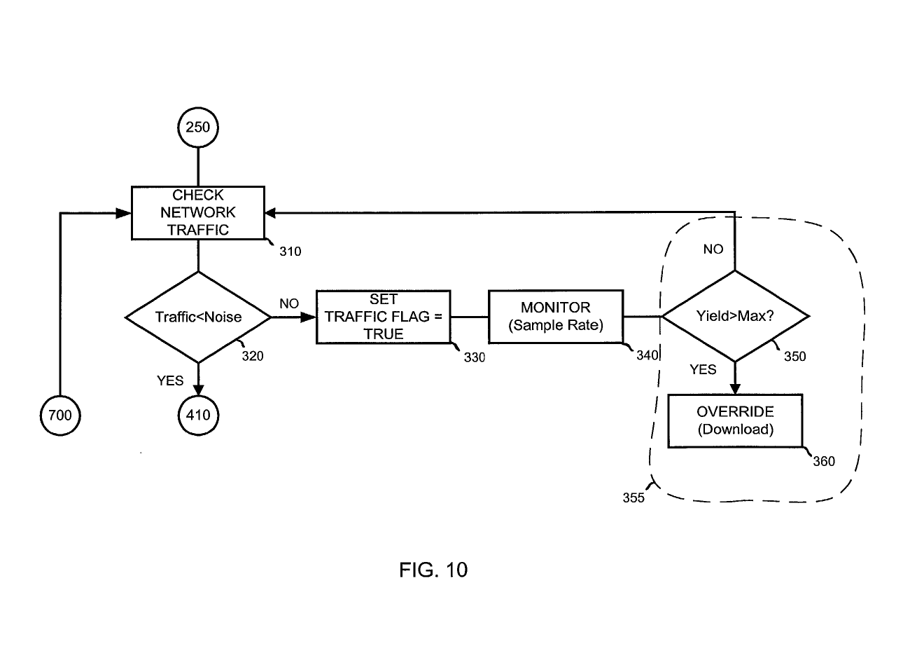

An alternative embodiment shown in FIG. 10 may include a routine indicated by reference 355 for resuming the download after a predetermined amount of time even though the detected network activity is above the predetermined Threshold Noise Level 225. Hence, the present alternative embodiment may be configured to terminate the loop represented by steps 310 through 350 of FIG. 10. If at step 350 the download task has been yielding an amount of time longer than the time defined by a Maximum Yield parameter, the system overrides the yielding state and resumes the download at step 360—regardless of the user's foreground network activity.

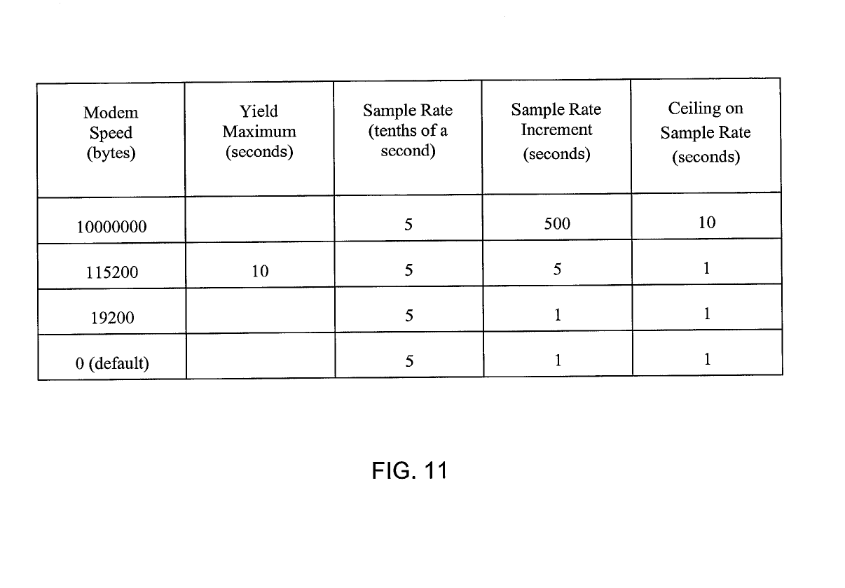

Since the user's online experience, such as browsing, has already been significantly degraded by the substantial bandwidth requirements of the foreground download task, the user will unlikely notice that the background download task has been resumed. Besides preventing large foreground tasks from dominating the network connection, the present embodiment also prevents the TCP/IP connection to a server or other host from being dropped. FIG. 11 is a table containing exemplary yield times (see column 2) for various network connection speeds.

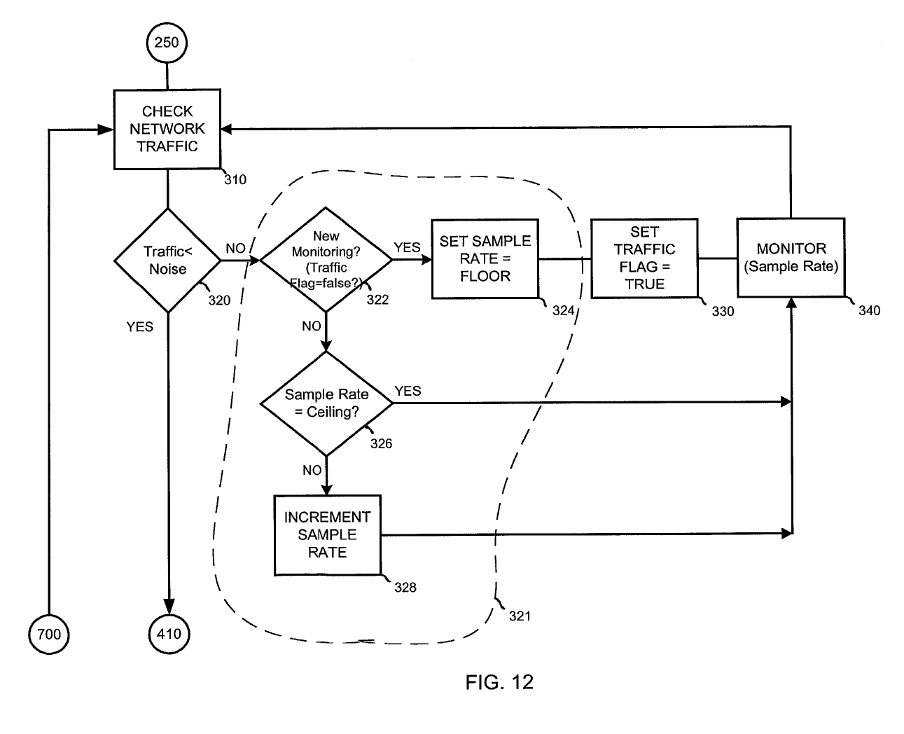

Another exemplary alternative embodiment shown in FIG. 12 may include a routine indicated by reference 321 for adapting the Sample Rate 235 according to the detected connection speed and the user's network activity. The Sample Rate 235 may be adjusted in a similar manner in which the download parameters are adjusted according to periods of inactivity.

After determining at step 320 of FIG. 12 that the network activity is higher than the Threshold Noise Level 225, the system queries at step 322 whether the network traffic flag is “false” (i.e., indicating the beginning of a new yielding period). If the traffic flag is “false”, the Sample Rate parameter 235 is reset according to its default value at step 324. The system pauses or sleeps for an amount of time at step 340 corresponding to the value of the Sample Rate parameter 235, then checks again at step 310 for network activity. On the other hand, if the traffic flag at step 322 indicates that a yielding period has already begun, the Sample Rate parameter may be adjusted.

In the present alternative embodiment, the Sample Rate may be progressively increased after successive detections of network activity until a value corresponding to a Ceiling on Sample Rate is reached. Hence, during periods of network activity 50 the Sample Rate 235 can be progressively increased, thereby decreasing the frequency of the network checks at step 310 of FIG. 12. As long as network activity is detected at step 310 is greater than the Threshold Noise Level 225 at step 320, the Sample Rate 235 or wait interval may be increased by a value corresponding to a Sample Rate Increment parameter at step 328 unless the Sample Rate 235 reaches a Ceiling On Sample Rate at step 326. The table shown in FIG. 11 also shows exemplary values for the Sample Rate, Sample Rate Increment, and the Ceiling on Sample Rate parameters.

It will be apparent to those skilled in the art that various modifications and variations can be made in the method and system for adaptively downloading data from a network device without departing from the spirit or scope of the invention. Thus, it is intended that the present invention cover the modifications and variations of this invention provided they come within the scope of the appended claims and their equivalents.

What is claimed is:

1. A client-based method for managing transfer of a file having data from a networked device to a client system having a network connection, comprising the steps of:
(a) monitoring utilization of the network connection;
(b) determining whether to receive data based on the utilization of the network connection;
(c) if step (b) determines to receive data, receiving data from the networked device using the method comprising:
(i) determining whether to adjust an amount of data received in a current iteration;
(ii) if step (i) determines to adjust the amount of data received, adjusting the amount of data to receive according to the type of network connection; and
(iii) receiving the amount of data;
(d) if step (b) determines not to receive data, pausing a predetermined amount of time before proceeding; and
(e) repeating steps (a)-(d) until all data in the file is received.

2. The method of claim 1, further comprising the step of determining a speed of the network connection.

3. The method of claim 1, further comprising the step of defining a size of a receiving buffer according to the type of network connection.

4. The method of claim 1, wherein the step of monitoring the utilization of the network connection includes the step of determining how much data has been transferred through the network connection per unit of time.

5. The method of claim 1, wherein the step of determining whether to receive data based on the utilization of the network connection includes the step of comparing the network utilization to a threshold noise parameter defined according to the type of network connection.

6. The method of claim 5, wherein the threshold noise parameter may by statically, dynamically, or user configurable.

7. The method of claim 1, wherein the step of determining whether to adjust the amount of data received in the current iteration includes determining whether the monitoring of the network connection in a previous iteration resulted in data being received.

8. The method of claim 1, wherein the step of adjusting the amount of data to receive according to the type of network connection includes adjusting a buffer parameter that determines how many times a receiving buffer is read in the current iteration.

9. The method of claim 8, wherein the step of adjusting a buffer parameter that determines how many times a receiving buffer is read in the current iteration includes incrementing the buffer parameter when monitoring of the network connection in the previous iteration resulted in data being received.

10. The method of claim 9, wherein the buffer is incremented until a predetermined maximum buffer value is achieved.

11. The method of claim 8, wherein the step of adjusting a buffer parameter that determines how many time a receiving buffer is read in the current iteration includes resetting the buffer parameter to a predetermined minimum value when the monitoring of the network connection in the previous iteration resulted in data not being received.

12. The method of claim 1, wherein the step of pausing a predetermined amount of time before proceeding includes the step of pausing a predetermined amount of time determined by the network connection type.

13. A system for managing the transfer of a file having data from a networked device to a client system, comprising:
means for determining a type of network connection of the client system;
means for defining a threshold parameter and a buffer parameter according to the type of network connection;
means for receiving an amount of data determined by the buffer parameter when the utilization of the network connection is below the threshold parameter and adjusting the buffer parameter according to the monitoring of the utilization of the network connection; and
means for suspending the receiving of data when utilization of the network connection is not below the threshold parameter and monitoring the utilization of the network connection.
